(19) United States
(12) Patent Application Publication
(10) Pub. No.: US 2006/0044250 A1
(43) Pub. Date: Mar. 2, 2006

(54) Display panel driving circuit

(76) Inventor: Katsuhiko Maki, Chino (JP)

Correspondence Address: HARNESS, DICKEY & PIERCE, P.L.C., P.O. BOX 828, BLOOMFIELD HILLS, MI, 48303, US

(21) Appl. No.: 11/191,194

(22) Filed: Jul. 27, 2005

(30) Foreign Application Priority Data
Aug. 30, 2004 (JP) 2004-249690

(51) Int. Cl. G09G 3/36

(52) U.S. Cl. 345/98

(57) ABSTRACT

A display panel driving circuit including: a memory for temporarily storing image data input in an interlace scan method; an image data adding circuit for adding image data representing a black-level or white-level image, to every image data equivalent to one frame, the image data being sequentially read out from the memory; an image signal supply circuit for converting the image data to a plurality of analog image signals, and for supplying the image signals to a display panel, the image data sequentially output from the image data adding circuit; and a control circuit for controlling a read-out operation of the image data from the memory and the image data adding circuit, as well as displaying the black-level or white-level image for every one frame period in the display panel

### BACKGROUND OF THE INVENTION

1. Technical Field

The present invention relates to a display panel driving circuit for driving a display panel, specifically to a Liquid Crystal Display (LCD) panel, in which the plurality of built-in Thin Film Transistors (TFT) are driven with an interlace scan method.

2. Related Art

The type of LCD panel in which a plurality of TFTs is built-in, has a display panel driving circuit (source driver) that drives a source of the TFT, and a display panel driving circuit (gate driver) that drives a gate of the TFT, both of which are connected to the LCD panel. The source driver converts image data of each line, sequentially read out from the Random Access Memory (RAM), to analog image signals, and provides these image signals to the source of the TFT.

On the other hand, the gate driver generates a gate electric-potential for turning on the TFTs in the selected line, and provides it to the gates of the TFTs. At the same time, it generates a common electric-potential Vcom that is applied to a second electrode (hereafter also referred to as “common electrode”), which is facing a plurality of first electrodes (hereafter also referred to as “dot electrode”) each of which are driven by the TFTs. The common electric-potential Vcom is inverted in a prescribed cycle, since the characteristic thereof deteriorates if a direct-current voltage is continuously applied to the LCD panel.

Generally, there are two methods employed for the inversion. One is a line inversion method, in which the common electric-potential Vcom is inverted per every line, and the other is a frame inversion method or a field inversion method, in which the common electric-potential Vcom is inverted per every frame or field. The line inversion method has high power consumption, while it provides a high image quality; therefore, it is desirable to employ the frame inversion method or the field inversion method, and to improve the quality of images thereof.

In addition, some LCD panels employ an interlace scan method, in which a scanning of one screen is performed in separate instances of scans by spacing the scannings. With this interlace scan, a display is conducted in a high resolution, using a relatively low-cost LCD panel. However, one frame is composed with a plurality of fields; therefore it involves the problem that the difference of images in those fields tends to be perceptible as a flicker.

As a related art, a liquid crystal driving device, which does not require expensive components such as a frame memory or the like, enables to reduce a cost, correspond to various kinds of input video signals such as the interlace signal etc., and does not limit the compliant liquid crystal system, is disclosed. Japanese Unexamined Patent Publication No. 2001-142044 (page 1, FIG. 1) is an example of this related art.

In this liquid crystal driving device, lines of liquid crystal are shifted by the number equivalent to that of VCK (vertical clock signal) lines input during the period when VOE (output enable signal) is high-level. Thereafter, a black level is written in to the shifted lines of liquid crystal, and the black band displayed on the liquid crystal panel is formed, with a field that is equivalent to several lines of VCK input during the period when the VOE of blanking period is in high level. Consequently, if an interlace signal is input, the black band part is displayed on the liquid crystal panel, at the end of the display period of one field.

Moreover, as another related art, a liquid crystal driving device, which uses an TN type liquid crystal material, and in which a liquid crystal panel is put to non-hold display, by inserting a non-display signal in a prescribed cycle into data signals input to a signal electrode, is disclosed. This liquid crystal driving device improves the blur of video image regardless of the level of the data signal. Japanese Unexamined Patent Publication No. 2002-132220 (page 1, FIG. 1) is an example of this related art.

This liquid crystal display device has a normally white display, inserts black signals for every other line in the progressive video image signal that is input, and changes the write-in location of the black signals per each frame; hence it displays data in interlace. This way, it is possible to write-in the image data into pixels only at the Toff side of the liquid crystal. In the case of nematic liquid crystal, the response speed of the Toff side is constant regardless of voltage applied to the liquid crystal; hence it is possible to improve the blur of the video image, regardless of the signal level of the video signals.

However, in these documents, how to reduce flickering in the interlace scan method, is not mentioned.

### SUMMARY

An advantage of the invention is to provide a system for a display panel driving circuit that drives the display panel so as to perform an interlace scan, which reduces flickering caused by the interlace scan method.

According to an aspect of the invention, the display panel driving circuit includes: a memory for temporarily storing image data input in an interlace scan method; an image data adding circuit for adding image data representing a black-level or white-level image, to every image data equivalent to one frame, the image data being sequentially read out from the memory; an image signal supply circuit for converting the image data to a plurality of analog image signals, and for supplying the image signals to a display panel, the image data sequentially output from the image data adding circuit; and a control circuit for controlling a read-out operation of the image data from the memory and the image data adding circuit, as well as displaying the black-level or white-level image for every one frame period in the display panel.

Here, the control circuit may be configured to control the read-out operation of image data for each line from the memory, so that a display starting line in the display panel is different per each prescribed number of frame periods. In this case, the control circuit may include: a counter that counts a signal which are in synchronization with a field period, and outputs a count value; and an address generation part that generates, in a prescribed order, an address of the image data for each line being read out from the memory, based on the count value output from the counter, and on a signal which are in synchronization with a line display period.

In the above case, a liquid display panel may be used as the display panel. In this case, the image signal supply circuit may apply the plurality of image signals to sources of a plurality of thin film transistors, each of the thin film transistors respectively driving each of a plurality of first electrodes in each line of the liquid crystal display panel. Furthermore, the control circuit may generate a gate driver control signal for controlling a gate driver, which applies a gate voltage to gates of a plurality of thin film transistors, each of the thin film transistors respectively driving each of the plurality of the first electrodes in each line, so that a plurality of lines in the liquid crystal display panel is driven in a prescribed order. Still further, the gate driver may invert a common electric-potential per every field, the common electric-potential being supplied in a prescribed order to a second electrode facing the plurality of the first electrodes in each line of the liquid crystal display panel.

### BRIEF DESCRIPTION OF THE DRAWINGS

The invention will be described with reference to the accompanying drawings, wherein like numbers refer to like elements, and wherein:

FIG. 1 is a drawing for showing connection relations in a display panel driving circuit in one embodiment of the invention;

FIG. 2 is a drawing for showing a part of the configuration of a source driver and of a LCD panel shown in FIG. 1;

FIG. 3 is a drawing for showing a configuration of one frame in one embodiment of the present invention;

FIG. 4 is a drawing for showing a configuration of a power circuit or the like in the source driver;

FIG. 5 is a drawing for showing a waveform of a clock signal used in a step-up circuit shown in FIG. 4;

FIG. 6 is a drawing for showing charge-discharge behavior of condensers in each status;

FIG. 7 is a drawing for showing a waveform of a common electric-potential output from a gate driver;

FIG. 8 is a drawing for showing a screen displayed on the LCD panel by the conventional display panel driving circuit;

FIG. 9 is a drawing for showing an order of lines displayed in each frame period; and

FIG. 10 is a drawing for showing a screen displayed by a display panel driving circuit in one embodiment of the invention.

### DESCRIPTION OF THE EMBODIMENTS

According to an embodiment of the invention, in a display panel driving circuit that drives a display panel so as to perform an interlace scan, a coherency of an image in one frame is visually stressed by displaying the black-level or the white-level image on the display panel in each frame period; hence flickering caused by the interlace scan method is reduced. Further, by controlling a read-out operation of image data, so that a display starting line in the display panel is different for each prescribed frame period, it is possible to reduce the unevenness of brightness within one field, even if a common electric-potential, supplied to the second electrode which is facing the first electrode in the liquid crystal display panel, is inverted per each field.

An embodiment of the invention will now be described in detail with references to the drawings. In the embodiment below, a LCD panel is used as the display panel.

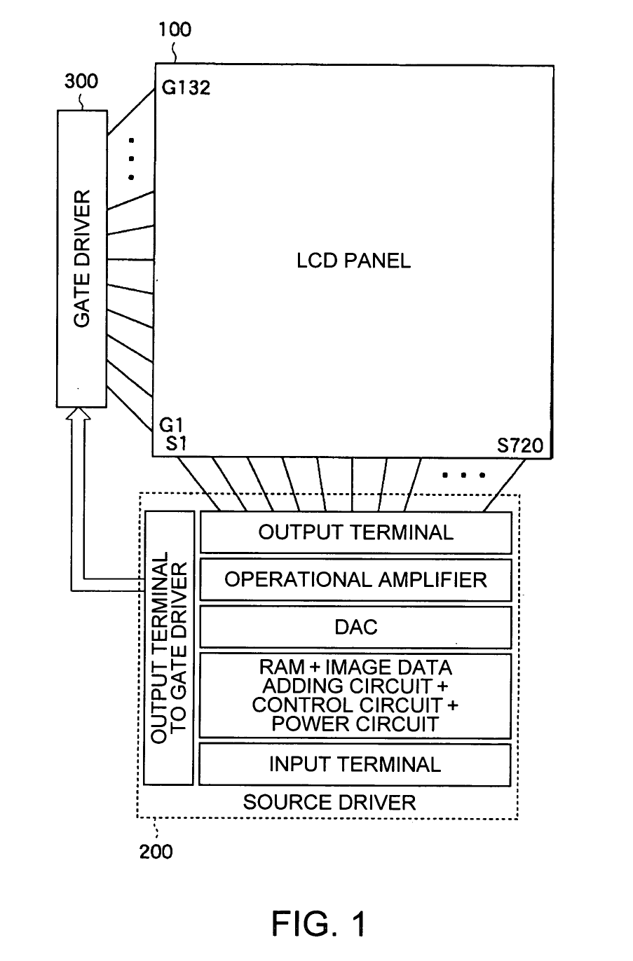

In FIG. 1, relations of a connection between a display panel driving circuit in one embodiment of the invention and the LCD panel, are shown. A LCD panel 100, which has 720*132 dots for instance, is provided with the same number of TFTs corresponding to these dots, arranged in a two-dimensional matrix. In order to drive the LCD panel 100, a display pane driving circuit (hereafter “source driver”) 200 that drives the sources of these TFTs is connected to source lines S1 through S720, and a display panel driving circuit (here after “gate driver”) 300 that drives the gates of these TFTs is connected to gate lines G1 through G132.

In the source driver 200, major components such as a RAM, an image data adding circuit, a power circuit, a DAC (Digital to Analog Converter), an operational amplifier, an input terminal, an output terminal, and an output terminal for the gate driver, are arranged.

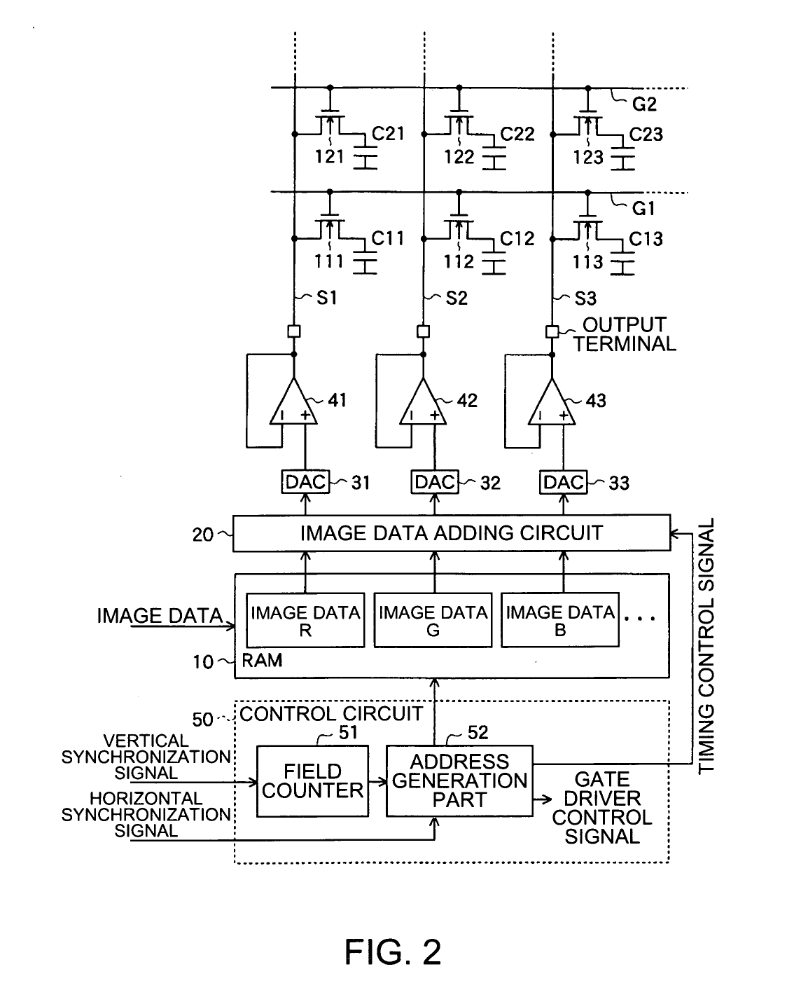

In FIG. 2 a part of the configuration of a source driver and of a LCD panel is shown. The source driver includes: a RAM 10 that temporarily stores input image data of red (R), green (G), and blue (B); an image data adding circuit 20 that adds image data representing a black-level or white-level image, to every image data equivalent to one frame, the image data being sequentially read out from the RAM 10; DACs 31, 32, 33 . . . for converting the three (RGB) kinds of image data of each line, sequentially output from the image data adding circuit 20, to a plurality of analog image signals; operational amplifiers 41, 42, 43 . . . for amplifying the image signals output from the DACs; and a control circuit 50 for controlling a read-out operation of the image data from the RAM 10 and the image data adding circuit 20, as well as displaying the black-level or white-level image for every one frame period in the LCD panel.

Image signals for each line amplified by the operational amplifiers 41, 42, 43 . . . are provided to the source lines S1, S2, S3 . . . . The source line S1 corresponds to TFTs 111, 121 . . . that drive dot electrodes in the first line of the LCD panel. Similarly, the source line S2 corresponds to TFTs 112, 122 . . . that drive dot electrodes in the second line, and the source line S3 corresponds to TFTs 113, 123 . . . that drives dot electrodes in the third line, and so on. Moreover, condensers C11, C21 . . . represent capacitors connected between drains of TFTs 111, 121 . . . and dot electrodes of the LCD panel.

Control circuit 50 includes a field counter 51 and an address generation part 52. The field counter 51 counts V (vertical) synchronization signals that synchronize to one field period, and outputs the obtained count value to the address generation part 52. Further, the address generation part 52 generates addresses of image data for each line, the image data being read out from the RAM 10, based on the count value and on the H (horizontal) synchronization signal that synchronize to the line display period. Moreover, the address generation part 52 generates a gate driver control signal for controlling the gate driver 300 (FIG. 1), as well as a timing control signal for controlling the image data adding circuit 20. Here, the count value in the field counter 51 is reset at the prescribed count value.

The image data output from the image data adding circuit 20 is converted to an analog signal by the DACs 31, 32, and 33 . . . Here, each of the DACs 31, 32, and 33 . . . is a resistive network DAC that uses plurality of resistors. By setting a resistance of these resistors to a value with a characteristic of y correction, it is possible to convert the input image data to an image signal in which the gamma correction is performed.

The analog image signals output from the DACs 31, 32, and 33 . . . are respectively input to the operation amplifiers 41, 42, and 43 . . . and are amplified. The image signals output from the operation amplifiers 41, 42 and 43 . . . are respectively provided to the source lines S1, S2 and S3 . . . of the LCD panel through a plurality of output terminals.

The image signal supplied to the source line S1 is applied to the sources of TFTs 111, 121 . . . , the image signal supplied to the source line S2 is applied to the sources of TFTs 112, 122 . . . , and the image signal supplied to the source line S3 is applied to the sources of TFTs 113, 123 . . . .

The gate driver 300 shown in FIG. 1, on the other hand, sequentially selects the lines corresponding to the image signal supplied from the source driver 200 to the LCD panel 100, according to the gate driver control signal supplied from the source driver 200. Thereafter, it supplies a high-level gate signal to one line selected from the gate lines G1, G2 . . . , and also supplies a common electric-potential Vcom to one common electrode selected from the plurality of common electrodes. Among the plurality of TFTs connected to one source line, the TFTs, which the gate line thereof is in high-level, are turned on, and the image signals are supplied to the dot electrodes that are connected to those TFTs through the capacitors. Consequently, an image is displayed on the LCD panel 100 by inserting black-level or white-level images into each frame period.

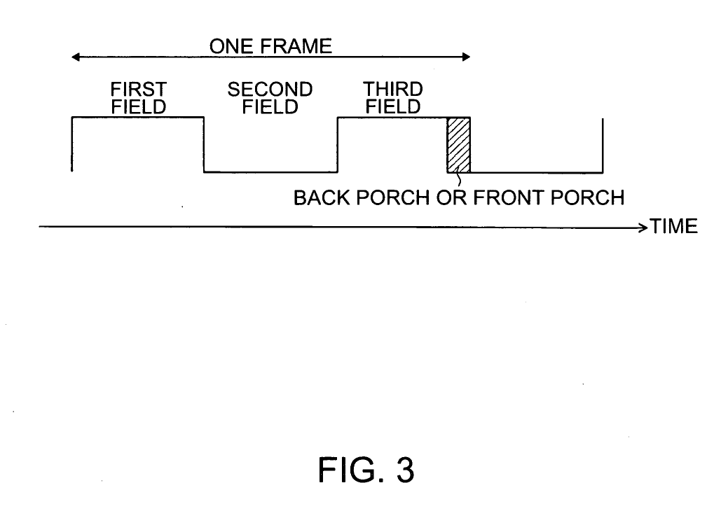

In FIG. 3, a configuration of one frame in the embodiment is shown. In this case, one frame is provided with first, second and third fields. Between one frame and the other, there is a part called a back porch or a front porch. Normally, TFT does not operate during this period, and on the LCD panel 100, an image right before this period is shown as is.

In contrast to the above, in the embodiment, an image signal that represents either a black-level or a white-level, is supplied to all the source lines during this back porch or front porch. At the same time, all the gate lines are set to high-level. Consequently, all the TFTs are operated and all the pixels that compose one frame are set to black-level or white-level. As described, by displaying the black-level or the white-level image on the LCD panel 100 per each frame period, a coherency of the image in one frame is visually stressed; hence it is possible to reduce a flickering caused by the interlace scan method

Hereafter, a problem in image quality if the field inversion method is employed, in which the common electric-potential is inverted for each field, is described.

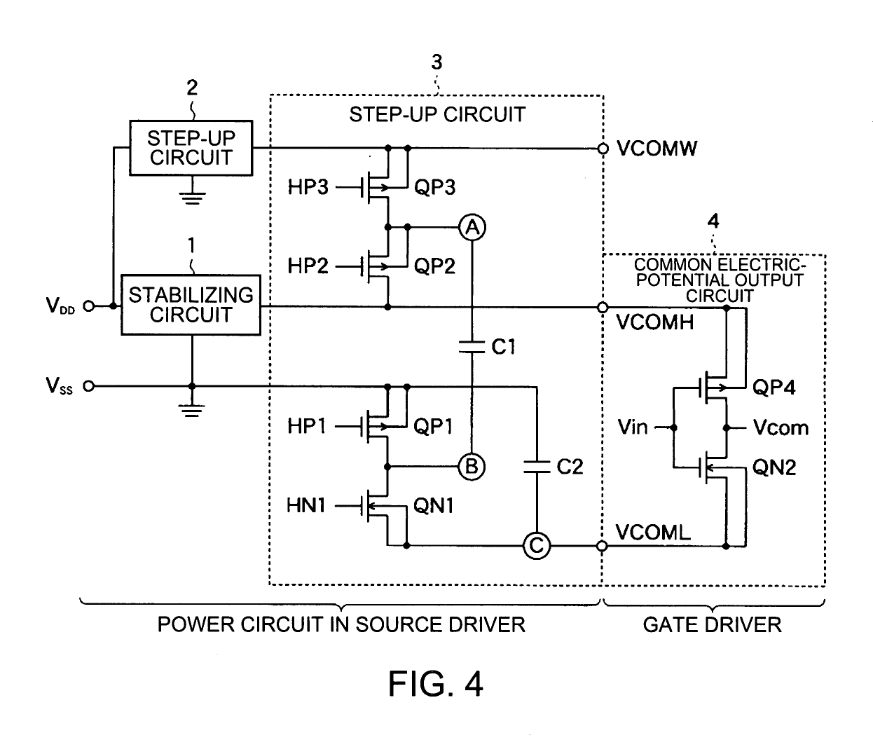

FIG. 4 is a drawing to show the configuration of the power circuit in the source driver, and of a common electric-potential output circuit in the gate driver. The electric circuit in the source driver includes: a stabilizing circuit 1, a step-up circuit 2 that generates a power electric-potential VCOMW by performing a step-up based on power electric-charges V_{DD} and V_{SS}, a step-up circuit 3 that generates a power electric-potential VCOML by performing a step-up based on power electric-charges VCOMH and V_{SS}. For instance, values for the power electric-potential V_{DD} and V_{SS} are 3V and 0V, and values for the power electric-potential VCOMW, VCOMH, and VCOML are respectively 5V, 2.5V and −2.5V.

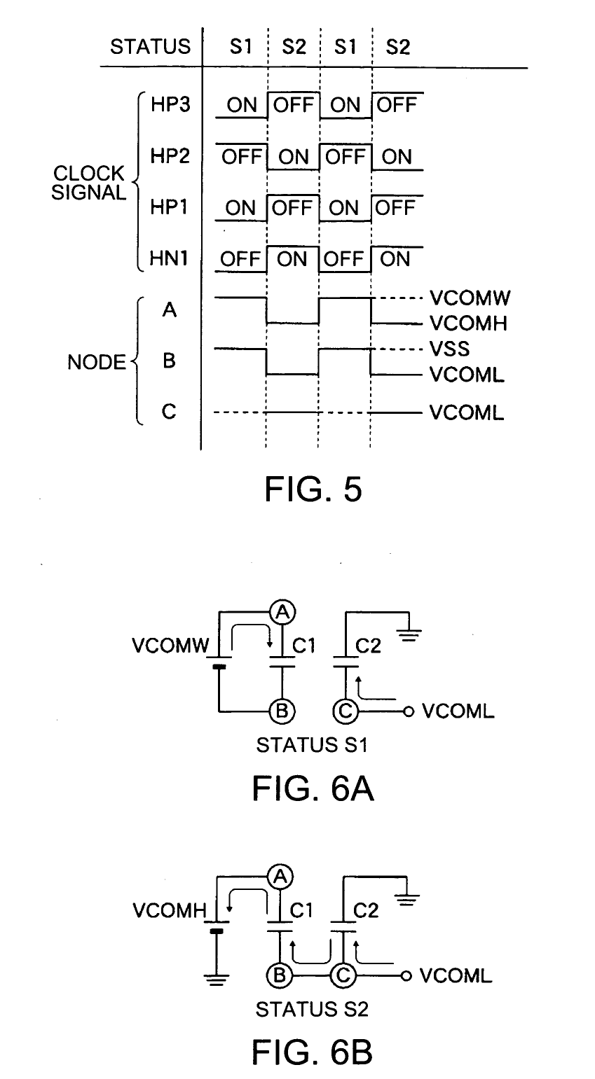

The step-up circuit 3 is configured with an N-channel MOS transistor QN1, P-channel MOS transistors QP1 through QP3, and condensers C1 and C2. Clock signals HN1 and HP1 through HP3, whose waveforms are shown in FIG. 5, are supplied to each of their corresponding gates; thus these transistors turning on and off repeatedly at statuses S1 and S2. Consequently, electric-potentials of the step-up operation change as indicated in FIG. 5, and the step-up operations are performed.

The power electric-potentials VCOMH and VCOML are supplied to a common electric-potential output circuit 4 in the gate driver that outputs the common electric-potential Vcom. The common electric-potential output circuit 4 is an inverter composed with the N-channel MOS transistor QN2 and the P-channel MOS transistor QP4, which inverts an input electric-potential Vin and outputs the common electric-potential Vcom.

In FIG. 6, the charge-discharge behavior of the condensers C1 and C2 in the statuses S1 and S2 is shown. In the status S1 shown in FIG. 6A, the condenser C1 is charged, while the power electric-potential VCOML needs to be retained with an electric charge stored in the condenser C2, since another terminal (the node C) of the condenser C2 is disconnected from the node B. On the other hand, in the status S2 shown in FIG. 6B, the power electric-potential VCOML can be retained with electric charges stored both in the condensers C1 and C2, since the node C and the node B are connected. Since there is a limit in the capacity of condenser, however, retaining the power electric-potential VCOML is particularly difficult in the status S1.

Meanwhile, a leakage current flows in the LCD panel; hence there is a current that flows between the common electrodes and the other electrodes, after the electric-potential of the common electrode has reached to a high-level or a low level. The problem here is whether or not the common electric-potential can be kept to a constant value, since one field period is relatively a long period of time, for instance, approximately 16.7 msec.

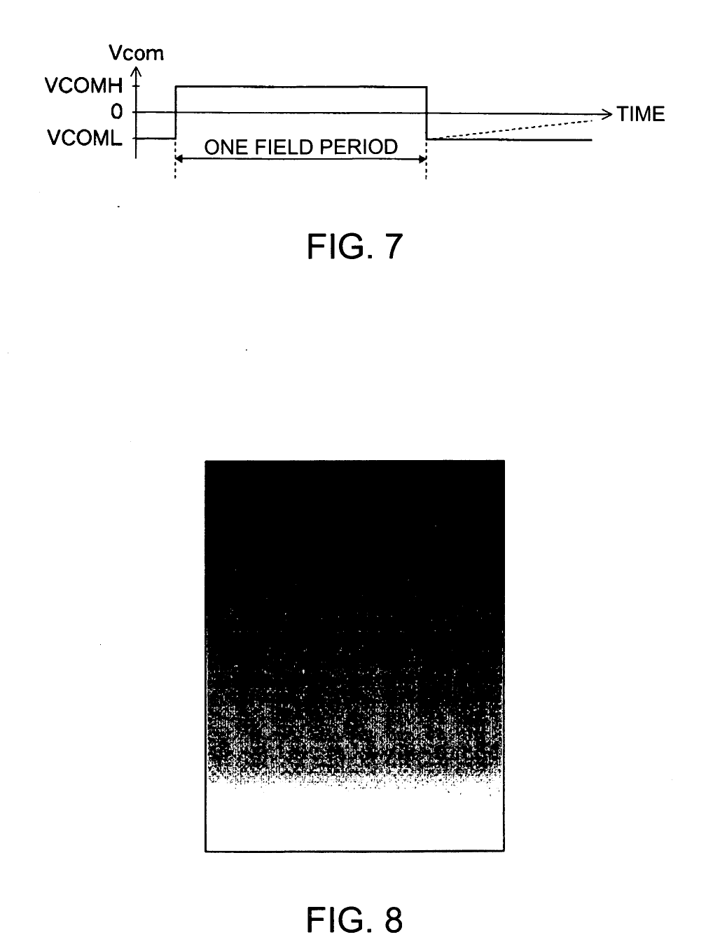

FIG. 7 is a drawing for showing a waveform of the common electric-potential Vcom output from the gate driver. The common electric-potential Vcom does not fluctuate during a field period when it is in high-level, since the power electric-charge VCOMH that governs the high-level of the common electric-potential Vcom is stabilized. On the other hand, the common electric-potential Vcom fluctuates during a field period when it is in low-level, since the power electric-charge VCOML that governs the low-level of the common electric-potential Vcom is not stabilized.

FIG. 8 is a drawing for showing a screen displayed on the LCD panel by the conventional display panel driving circuit. As mentioned above, if the common electric-potential Vcom fluctuates, the low-level common electric-potential Vcom is set off from its low-level, even if the image data, representing an evenly gray image, is input to the source driver; hence a phenomenon, in which the lower part of the screen gets brighter, occurs. In the field inversion method, improvement against such image quality degradation is desired.

Therefore, the control circuit 50 changes the driving order of the plurality of lines in the LCD panel, so that the display starting line in the LCD panel is different per each prescribed number of frame periods, for example per one frame period.

Consequently, the field counter 51 counts V (vertical) synchronization signals that synchronize to one field period, and outputs the obtained count value to the address generation part 52. Further, the address generation part 52 generates the addresses of the image data for each line, the image data being read out from the RAM 10, based on the count value and on the H (horizontal) synchronization signal that synchronize to the line display period. At the same time, the gate driver control signal for controlling the gate driver 300 (FIG. 1) is generated. Here, the count value in the field counter 51 is reset at the prescribed count value.

The gate driver 300 shown in FIG. 1, on the other hand, sequentially selects the lines corresponding to the image signal supplied from the source driver 200 to the LCD panel 100, according to the gate driver control signal supplied from the source driver 200. Thereafter, it supplies a high-level gate signal to one line selected from the gate lines G1, G2 . . . , and also supplies a common electric-potential Vcom to one common electrode selected from the plurality of common electrodes. From the plurality of TFTs connected to one source line, the ones in which the gate line is in high-level are turned on, and the image signals are supplied to the dot electrodes connected to those TFTs through capacitors. Consequently, an image is displayed on the LCD panel 100 by modifying the display starting line per every prescribed number of frame periods.

It has been common that in any frame period, the display starting lines in the display panel are identical. For instance, in any frame period, the first line has been displayed first, thereafter the second line has been displayed, and finally the 132nd line has been displayed last. In contrast to the above, in the embodiment, the display starting line in the display panel is modified per each prescribed number of frame periods, based on the count value obtained by counting the V synchronization signals with the field counter 51 shown in FIG. 2.

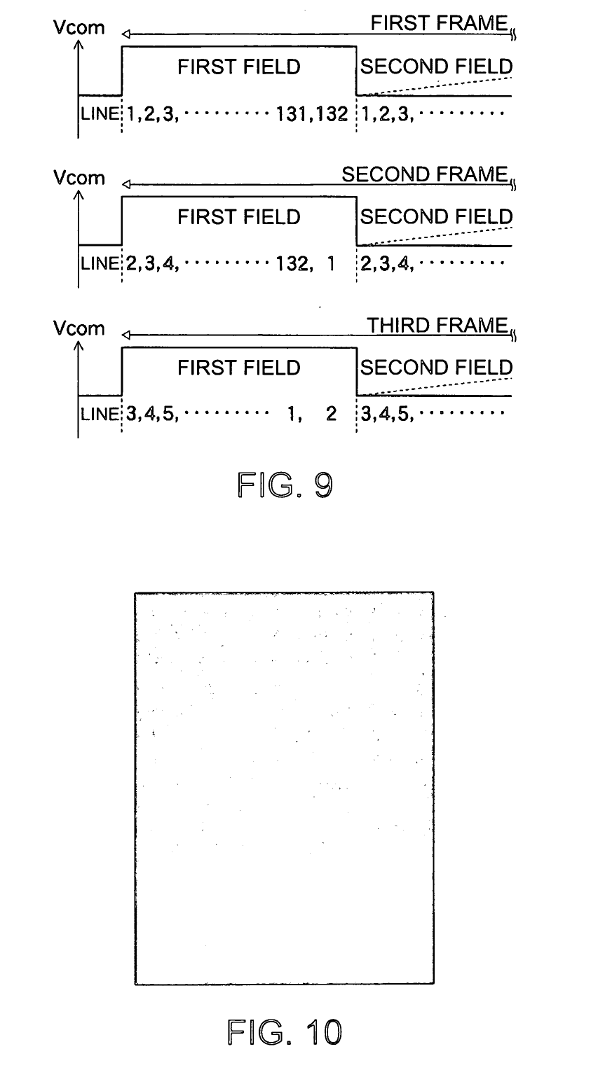

As shown in FIG. 9, in the first frame period, the first line is displayed first, thereafter the second line is displayed, and finally the 132nd line is displayed last. Further, in the second frame period, the second line is displayed first, thereafter the third line is displayed, and finally the first line is displayed last. Still further, in the third frame period, the third line is displayed first, thereafter the forth line is displayed, and finally the second line is displayed last. The case shown in FIG. 9 is when the number of fields included in one frame is an even number.

FIG. 10 is a drawing for showing a screen displayed on the LCD panel by the display panel driving circuit in the embodiment. Here, image data representing an evenly gray image is input to the source driver. By modifying the order in which the plurality of lines are displayed in the display panel, the unevenness of brightness within one frame is reduced, since the change of the brightness in each line undergoes the differentiation inverse, even if the common electric-potential Vcom fluctuates in one frame period, as shown in FIG. 9. Unevenness that occurs in the frame cycle as a result of other causes can also be reduced.

With the embodiment, in a display panel driving circuit that drives the LCD panel so as to perform the interlace scan, the coherency of the image in one frame is visually stressed by displaying the black-level or the white-level image on the LCD panel in each frame period; hence the flickering caused by the interlace scan method can be reduced. Moreover, the unevenness of the brightness within one frame can be reduced, while employing the field inversion method that has low power consumption.

What is claimed is:

1. A display panel driving circuit comprising:
a memory for temporarily storing image data input in an interlace scan method;
an image data adding circuit for adding image data representing a black-level or white-level image, to every image data equivalent to one frame, the image data being sequentially read out from the memory;
an image signal supply circuit for converting the image data to a plurality of analog image signals, and for supplying the image signals to a display panel, the image data sequentially output from the image data adding circuit; and
a control circuit for controlling a read-out operation of the image data from the memory and the image data adding circuit, as well as displaying the black-level or white-level image for every one frame period in the display panel.

2. The display panel driving circuit according to claim 1, wherein the control circuit controls the read-out operation of the image data of each line from the memory, so that a display starting line in the display panel is different per each prescribed number of frame periods.

3. The display panel driving circuit according to claim 2, wherein the control circuit includes:
a counter that counts a signal which are in synchronization with a field period, and outputs a count value; and
an address generation part that generates, in a prescribed order, an address of the image data for each line being read out from the memory, based on the count value output from the counter, and on a signal which are in synchronization with a line display period.

4. The display panel driving circuit according to claim 1, wherein the display panel is a liquid crystal display panel.

5. The display panel driving circuit according to claim 4, wherein the image signal supply circuit applies the plurality of image signals to sources of a plurality of thin film transistors, each of the thin film transistors respectively driving each of a plurality of first electrodes in each line of the liquid crystal display panel.

6. The display panel driving circuit according to claim 5, wherein the control circuit generates a gate driver control signal for controlling a gate driver, which applies a gate voltage to gates of a plurality of thin film transistors, each of the thin film transistors respectively driving each of the plurality of the first electrodes in each line, so that a plurality of lines in the liquid crystal display panel is driven in a prescribed order.

7. The display panel driving circuit according to claim 6, wherein the gate driver inverts a common electric-potential per every field, the common electric-potential being supplied in a prescribed order to a second electrode facing the plurality of the first electrodes in each line of the liquid crystal display panel.
